(19) United States
(12) Patent Application Publication
(10) Pub. No.: US 2018/0017764 A1
(43) Pub. Date: Jan. 18, 2018

(54) PHOTOGRAPHIC LENS AND PHOTOGRAPHIC APPARATUS INCLUDING THE SAME

(71) Applicant: KOLEN CO., LTD., Gyeonggi-do (KR)

(72) Inventors: Chan Goo Kang, Gyeonggi-do (KR); Jong Jin Lee, Seoul (KR); Chi Ho Ahn, Gyeonggi-do (KR); Ji Eun Kim, Gyeonggi-do (KR)

(21) Appl. No.: 15/209,504

(22) Filed: Jul. 13, 2016

(51) Int. Cl. G02B 13/00; G02B 27/00; G02B 9/60

(52) U.S. Cl. CPC G02B 13/0045; G02B 9/60; G02B 27/0025

(57) ABSTRACT

A photographic lens includes: a first lens having a positive refractive power; a second lens having a negative refractive power; a third lens having a positive refractive power; a fourth lens having a positive refractive power; and a fifth lens having a negative refractive power, wherein the first to fifth lenses are sequentially arranged in a direction from an object toward an image plane, and the photographic lens satisfies the following conditions:

75°<FOV<90°

0.7<TTL/ImgH<0.8

where FOV refers to a field of view of the photographic lens, TTL refers to a distance measured along an optical axis from an entrance surface of the first lens to the image plane, and imgH refers to an image height.

### BACKGROUND

### 1. Field

One or more embodiments relate to a photographic lens, and more particularly, to a photographic lens having a small size and optical performance for use in devices such as cellular phone cameras.

### 2. Description of the Related Art

Recently, the use of cameras including solid-state imaging devices such as charge coupled devices (CCDs) or complementary metal oxide semiconductor (CMOS) image sensors has greatly increased.

Also, the degree of pixel integration in solid-state imaging devices has increased to improve the resolution of cameras. Along with this, small and lightweight cameras have been developed by improving the performance of photographic lenses included in the cameras. Recently, photographic apparatuses including solid-state imaging devices have been applied to mobile devices such as smartphones because such photographic apparatuses are suitable for miniaturization.

In general, the optical performance of cameras can be guaranteed by using many lenses. In this case, however, it is difficult to reduce the size, weight, and manufacturing costs of cameras. On the other hand, if the number of lenses included in cameras is decreased, aberrations may not be sufficiently corrected even though it may be effective in reducing product sizes and improving price competitiveness.

In addition, customers' knowledge about cameras have consistently increased, and thus camera designs for reducing product sizes and guaranteeing intended optical performance have been required. Therefore, it is necessary to design photographic lenses that are effective in size reduction, weight reduction, and cost reduction as well as in providing intended performance.

### SUMMARY

One or more embodiments include a photographic lens effective in size/weight reduction and having a high degree of performance.

Additional aspects will be set forth in part in the description which follows and, in part, will be apparent from the description, or may be learned by practice of the presented embodiments.

According to one or more embodiments, a photographic lens includes: a first lens having a positive refractive power; a second lens having a negative refractive power; a third lens having a positive refractive power; a fourth lens having a positive refractive power; and a fifth lens having a negative refractive power, wherein the first to fifth lenses are sequentially arranged in a direction from an object toward an image plane, and the photographic lens satisfies the following conditions:

75°<FOV<90°

0.7<TTL/ImgH<0.8

where FOV refers to a field of view of the photographic lens, TTL refers to a distance measured along an optical axis from an entrance surface of the first lens to the image plane, and imgH refers to an image height.

The entrance surface of the first lens may be convex toward the object.

An entrance surface of the second lens may be flat.

An exit surface of the third lens may be concave toward the image plane.

An exit surface of the fourth lens may be convex toward the image plane.

An exit surface of the fifth lens may be an aspherical surface having at least one inflection point.

The first to fifth lenses may include a plastic material, and each of the first to fifth lenses may be an aspherical plastic lens having at least one aspherical surface.

The photographic lens may satisfy the following condition:

1.6<(Ind2+Ind3)/2<1.7

where Ind2 refers to a refractive index of the second lens, and ind3 refers to a refractive index of the third lens.

The photographic lens may further include an aperture stop at an object-side of the first lens.

The photographic lens may satisfy the following condition:

0.9<AL/TTL<1.0

where AL refers to a distance from the aperture stop to the image plane, and TTL refers to the distance measured along the optical axis from the entrance surface of the first lens to the image plane.

According to one or more embodiments, a photographic lens includes: a first lens having a positive refractive power; a second lens having a negative refractive power and a flat entrance surface; a third lens having a positive refractive power; a fourth lens having a positive refractive power; and a fifth lens having a negative refractive power and an aspherical exit surface, the aspherical exit surface of the fifth lens having at least one inflection point, wherein the first to fifth lenses are sequentially arranged in a direction from an object toward an image plane, and the photographic lens satisfies the following condition:

75°<FOV<90°

where FOV refers to a field of view of the photographic lens.

The photographic lens may satisfy the following condition:

0.7<TTL/ImgH<0.8

where TTL refers to a distance measured from an optical axis from an entrance surface of the first lens to the image plane, and imgH refers to an image height.

The photographic lens may satisfy the following conditions:

1.6<Ind2<1.7

1.6<Ind3<1.7

where Ind2 refers to a refractive index of the second lens, and ind3 refers to a refractive index of the third lens.

According to one or more embodiments, a photographic apparatus includes: one of the photographic lenses; and an image sensor converting an optical image formed by the photographic lens into an electric signal.

### BRIEF DESCRIPTION OF THE DRAWINGS

These and/or other aspects will become apparent and more readily appreciated from the following description of the embodiments, taken in conjunction with the accompanying drawings in which:

FIG. 1 is a cross-sectional view illustrating an optical arrangement of a photographic lens according to a first embodiment;

FIG. 2 illustrates a longitudinal spherical aberration, astigmatic field curves, and distortion of the photographic lens of the first embodiment;

FIG. 3 is a cross-sectional view illustrating an optical arrangement of a photographic lens according to a second embodiment;

FIG. 4 illustrates a longitudinal spherical aberration, astigmatic field curves, and distortion of the photographic lens of the second embodiment;

FIG. 5 is a cross-sectional view illustrating an optical arrangement of a photographic lens according to a third embodiment; and

FIG. 6 illustrates a longitudinal spherical aberration, astigmatic field curves, and distortion of the photographic lens of the third embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Embodiments will now be described with reference to the accompanying drawings. In the drawings, like reference numbers refer to like elements, and the sizes of elements may be exaggerated for clarity of illustration.

The embodiments described herein are for illustrative purposes only, and various modifications may be made therefrom. In the following description, an object-side surface of each lens refers to a surface of the lens facing an object OBJ, that is, a left surface of the lens in the drawings. In addition, an image-side surface of each lens refers to a surface of the lens facing an image plane IMG, that is, a right surface of the lens in the drawings. The object-side surface of each lens may be referred to as an entrance surface, and the image-side surface of each lens may be referred to as an exit surface.

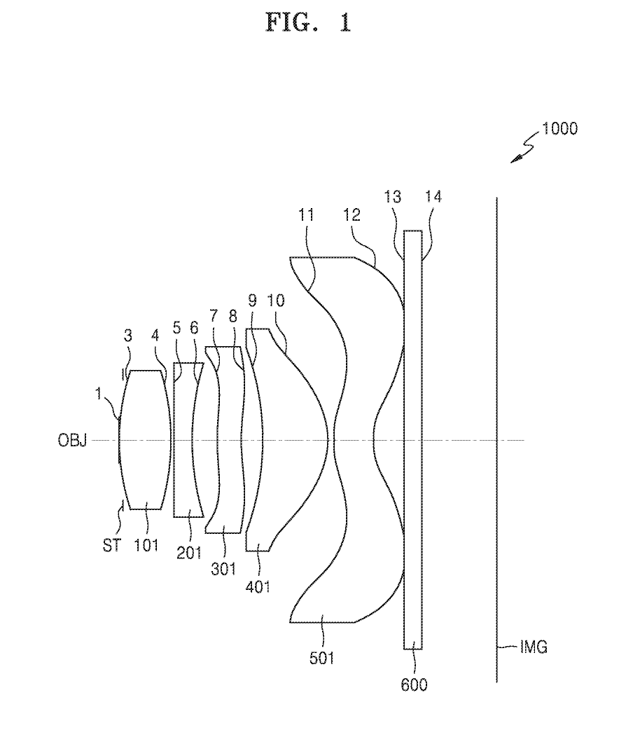

FIG. 1 is a cross-sectional view illustrating an optical arrangement of a photographic lens 1000 according to a first embodiment.

Referring to FIG. 1, the photographic lens 1000 may include a first lens 101 having a positive refractive power, a second lens 201 having a negative refractive power, a third lens 301 having a positive refractive power, a fourth lens 401 having a positive refractive power, and a fifth lens 501 having a negative refractive power, and the first to fifth lenses 101 to 501 may be sequentially arranged in a direction from an object OBJ toward an image plane IMG.

An image sensor (not shown) such as a charge coupled device (CCD) image sensor or a complementary metal oxide semiconductor (CMOS) image sensor may be placed on the image plane IMG.

An infrared-cut filter 600 may be placed between the fifth lens 501 and the image plane IMG. However, this is a non-limiting example. That is, in another example, the infrared-cut filter 600 may be omitted. In another example, a cover glass part may be arranged selectively or together with the infrared-cut filter 600.

An aperture stop ST may be placed at a side of an entrance surface of the first lens 101. However, the position of the aperture stop ST is not limited thereto.

The shape of each lens of the photographic lens 1000 is designed in order to reduce the size and weight of the photographic lens 1000, impart a wide field of view to the photographic lens 1000, and easily correct aberrations of the photographic lens 1000.

The photographic lens 1000 may satisfy the following condition:

75°<FOV<90° (1)

where FOV refers to a field of view of the photographic lens 1000.

Condition 1 guarantees a wide FOV.

Condition 1 may be modified as shown below and applied to the photographic lens 1000.

80°<FOV<85° (1-1)

The photographic lens 1000 may also satisfy the following condition:

0.7<TTL/imgH<0.8 (2)

where TTL refers to a total length of the photographic lens 1000, that is, a distance measured along an optical axis from the entrance surface of the first lens 101 to the image plane IMG, and imgH refers to an image height. The image height may be a length measured from a center of the image plane IMG along a diagonal direction. That is, the image height may be half of the diagonal length of an effective pixel region of the image sensor.

Condition 2 regulates the total length of the photographic lens 1000 with respect to the effective pixel region. Condition 2 guarantees the construction of an optical system having a short total length. If TTL/imgH is smaller than the lower limit of Condition 2, the total length of the photographic lens 1000 may be further reduced. In this case, however, it may be difficult to correct aberration. If TTL/imgH is greater than the upper limit of Condition 2, aberration may easily be corrected. However, the total length of the photographic lens 1000 increases, and thus it may be difficult to reduce the size of the photographic lens 1000.

The photographic lens 1000 may also satisfy the following condition:

0.9<AL/TTL<1.0 (3)

where AL refers to a distance from the aperture stop ST to the image plane IMG, and TTL refers to the distance measured along the optical axis from the entrance surface of the first lens 101 to the image plane IMG.

The photographic lens 1000 may also satisfy the following condition:

1.6<(Ind2+Ind3)/2<1.7 (4)

where ind2 refers to the refractive index of the second 201, and ind3 refers to the refractive index of the third lens 301.

Condition 4 regulates the refractive index of the second lens 201 and the refractive index of the third lens 301 to be within a numerical range so that the second lens 201 and the third lens 301 may be formed of an inexpensive plastic material.

Condition 4 may be modified as shown below and applied to the photographic lens 1000.

1.6<Ind2<1.7 (4-1)

1.6<Ind3<1.7 (4-2)

That is, the refractive index of the second lens 201 and the refractive index of the third lens 301 may respectively satisfy Conditions 4-1 and 4-2. In general, the refractive indexes of glass materials are greater than the refractive indexes of plastic materials. However, glass materials are heavier and more expensive than plastic materials. In addition, conditions for forming lenses using glass materials are stricter than conditions for forming lenses using plastic materials. If an intended refractive power is obtained using a material satisfying Condition 4, the photographic lens 1000 may be lightweight and may easily be manufactured with low costs.

Shapes of each lens of the photographic lens 1000 will now be described.

The first lens 101 may have a positive refractive power, and the entrance surface of the first lens 101 may be convex toward the object OBJ. For example, the first lens 101 may be a biconvex lens.

The second lens 201 may have a negative refractive power, and an entrance surface of the second lens 201 may be flat. The second lens 201 may be a flat-concave lens, and if one surface of the second lens 201 is flat as described above, the second lens 201 may easily be formed or machined compared with the case in which the second lens 201 has only curved surfaces. That is, the second lens 201 may be manufactured with high productivity, for example, within a relatively short production time.

The third lens 301 may have a positive refractive power, and an exit surface of the third lens 301 may be concave toward the image plane IMG.

The fourth lens 401 may have a positive refractive power, and an exit surface of the fourth lens 401 may be convex toward the image plane IMG. For example, the fourth lens 401 may have a meniscus shape convex toward the image plane IMG.

The fifth lens 501 may have a negative refractive power, and an exit surface of the fifth lens 501 may be an aspherical surface having at least one inflection point.

The first to fifth lenses 101 to 501 may include a glass material or a plastic material. For example, at least one of the first to fifth lenses 101 to 501 may include a plastic material for size reduction. In addition, for aberration correction, at least one of the first to fifth lenses 101 to 501 may have at least one aspherical surface. In this case, the at least one lens having at least one aspherical surface may include a plastic material to make it easy to perform manufacturing processes. In addition, all of the first to fifth lenses 101 to 501 may be aspherical plastic lenses for easy aberration correction, weight reduction, and cost reduction.

Hereinafter, lens data will be described according to embodiments. In lens data, ST denotes an aperture stop, and “*” at the rear of the surface number of a surface denotes that the surface is aspherical. R, T, Nd, and Vd denote a radius of curvature, a thickness or interval, a refractive index, and an Abbe number, respectively. In addition, Fno. denotes an F-number, and f denotes a focal length. Focal lengths, radii of curvature, and thicknesses or intervals are expressed in millimeters (mm).

Aspherical surfaces are defined as follows.

$$Z = \frac{{Y}^{2}}{R ( 1 + \sqrt{1 - ( 1 + K ) {Y}^{2} / {R}^{2}}} + {AY}^{ 4} + {BY}^{ 6} + {CY}^{ 6} + {DY}^{ 10} \qquad [ Equation 1 ]$$

where Z denotes a distance measured from the vertex of a lens in the direction of the optical axis of the lens, Y denotes a distance measured from the optical axis in a direction perpendicular to the optical axis, K denotes a conic constant, A, B, C, and D denote aspherical surface coefficients, and R denotes the radius of curvature at the vertex of the lens.

### First Embodiment

FIG. 1 is a cross-sectional view illustrating the optical arrangement of the photographic lens 1000 of the first embodiment, and lens data of the first embodiment are shown below.

TABLE 1
FNo. = 2.24/f = 3.324 mm

| Surfaces | R | T | Nd | Vd |
|---|---|---|---|---|
| 1 | Infinity | 0.05 | | |
| ST | Infinity | −0.05 | | |
| 3* | 2.0896 | 0.6429 | 1.546 | 56.092 |
| 4* | −5.0383 | 0.03 | | |
| 5 | Infinity | 0.22 | 1.644 | 23.517 |
| 6* | 3.064 | 0.3199 | | |
| 7* | 3.5594 | 0.2892 | 1.644 | 23.517 |
| 8* | 3.6477 | 0.2631 | | |
| 9* | −1.9011 | 0.787 | 1.546 | 56.092 |
| 10* | −0.9881 | 0.1 | | |
| 11* | 1.3664 | 0.48 | 1.546 | 56.092 |
| 12* | 0.7371 | 0.3767 | | |
| 13 | Infinity | 0.21 | | |
| 14 | Infinity | 0.9256 | | |
| IMG | Infinity | −0.0056 | | |

The following table shows aspherical surface coefficients.

TABLE 2

| Surfaces | K | A | B | C | D |
|---|---|---|---|---|---|
| 3 | −0.8368 | −0.0118 | −0.0586 | 0.0058 | 0.0144 |
| 4 | 0 | −0.026 | −0.1281 | 0.0497 | 0.0056 |
| 6 | −11.1956 | −0.0162 | 0.1251 | −0.1259 | 0.0606 |
| 7 | 0 | −0.2113 | −0.0845 | 0.0643 | −0.1121 |
| 8 | 0 | −0.0805 | −0.1054 | 0.1009 | −0.0698 |
| 9 | −18.4283 | −0.0654 | 0.1169 | −0.0935 | 0.0318 |
| 10 | −1.1596 | 0.0773 | −0.0726 | 0.0192 | −0.0023 |
| 11 | −8.9199 | −0.0927 | −0.0195 | 0.0204 | −0.0038 |
| 12 | −3.692 | −0.1129 | 0.0434 | −0.0136 | 0.0024 |

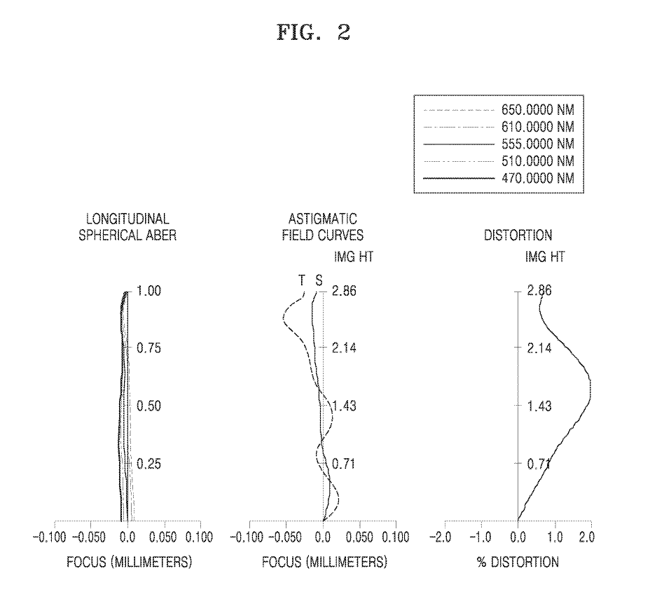

FIG. 2 illustrates a longitudinal spherical aberration, astigmatic field curves, and distortion of the photographic lens 1000 of the first embodiment. In FIG. 2, the longitudinal spherical aberration is plotted with respect to light having wavelengths of 650 nm, 610 nm, 555 nm, 510 nm, and 470 nm, and the astigmatic field curves and distortion are plotted with respect to light having a wavelength of 555 nm. Regarding the astigmatic field curves, a sagittal field curvature and a tangential field curvature are denoted by S and T, respectively.

### Second Embodiment

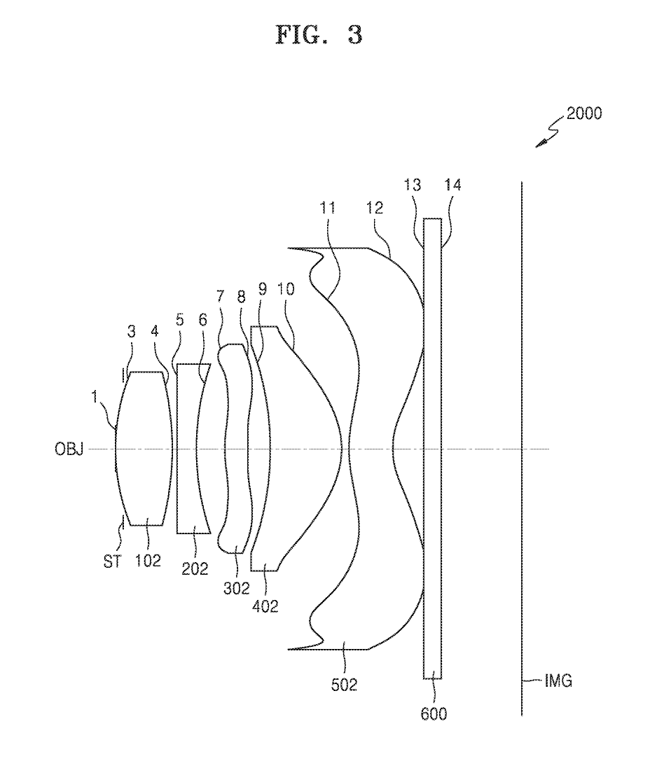

FIG. 3 is a cross-sectional view illustrating an optical arrangement of a photographic lens 2000 according to a second embodiment.

The photographic lens 2000 includes a first lens 102 having a positive refractive power, a second lens 202 having a negative refractive power, a third lens 302 having a positive refractive power, a fourth lens 402 having a positive refractive power, and a fifth lens 502 having a negative refractive power, and the first to fifth lenses 102 to 502 are sequentially arranged in a direction from an object OBJ toward an image plane IMG.

Lens data of the second embodiment are shown below.

TABLE 3
FNo. = 2.24/f = 3.3706 mm

| Surfaces | R | T | Nd | Vd |
|---|---|---|---|---|
| 1 | Infinity | 0.08 | | |
| ST | Infinity | −0.08 | | |
| 3* | 2.0156 | 0.645 | 1.546 | 56.092 |
| 4* | −6.3043 | 0.0423 | | |
| 5 | Infinity | 0.22 | 1.644 | 23.517 |
| 6* | 3.2632 | 0.3409 | | |
| 7* | 3.2048 | 0.2555 | 1.644 | 23.517 |
| 8* | 3.2674 | 0.2572 | | |
| 9* | −1.9851 | 0.8179 | 1.546 | 56.092 |
| 10* | −0.9709 | 0.1 | | |
| 11* | 1.5186 | 0.4924 | 1.546 | 56.092 |
| 12* | 0.7502 | 0.3547 | | |
| 13 | Infinity | 0.21 | | |
| 14 | Infinity | 0.9248 | | |
| IMG | Infinity | −0.0048 | | |

The following table shows aspherical surface coefficients.

TABLE 4

| Surfaces | K | A | B | C | D |
|---|---|---|---|---|---|
| 3 | −0.0605 | −0.0103 | −0.0587 | 0.023 | −0.0223 |
| 4 | 0 | −0.0478 | −0.1025 | 0.0379 | −0.014 |
| 6 | −1.7067 | −0.021 | 0.1187 | −0.0729 | 0.016 |
| 7 | 0 | −0.2158 | −0.081 | 0.0756 | −0.1379 |
| 8 | 0 | −0.0969 | −0.1011 | 0.0942 | −0.0651 |
| 9 | −19.6616 | −0.0714 | 0.1233 | −0.0946 | 0.0275 |
| 10 | −1.2021 | 0.0752 | −0.0756 | 0.0183 | −0.0034 |
| 11 | −12.2398 | −0.0982 | −0.0148 | 0.0174 | −0.0032 |
| 12 | −3.9886 | −0.1117 | 0.0435 | −0.0139 | 0.0024 |

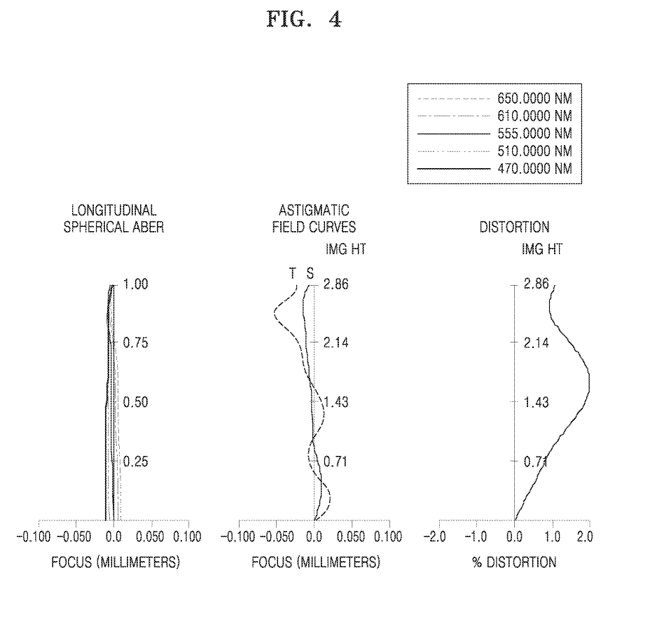

FIG. 4 illustrates a longitudinal spherical aberration, astigmatic field curves, and distortion of the photographic lens 2000 of the second embodiment.

### Third Embodiment

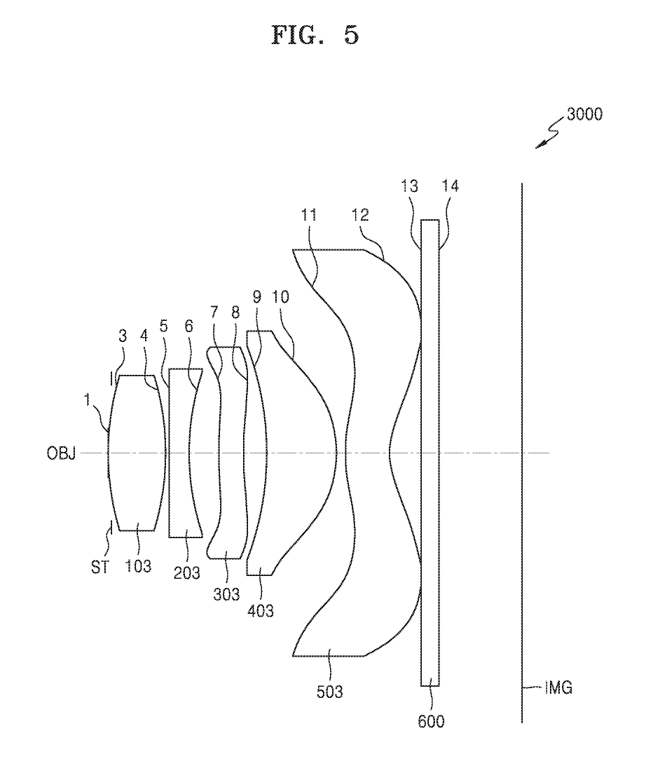

FIG. 5 is a cross-sectional view illustrating an optical arrangement of a photographic lens 3000 according to a third embodiment.

The photographic lens 3000 includes a first lens 103 having a positive refractive power, a second lens 203 having a negative refractive power, a third lens 303 having a positive refractive power, a fourth lens 403 having a positive refractive power, and a fifth lens 503 having a negative refractive power, and the first to fifth lenses 103 to 503 are sequentially arranged in a direction from an object OBJ toward an image plane IMG.

Lens data of the third embodiment are shown below.

TABLE 5
FNo. = 2.24/f = 3.3563 mm

| Surfaces | R | T | Nd | Vd |
|---|---|---|---|---|
| 1 | Infinity | 0.05 | | |
| ST | Infinity | −0.05 | | |
| 3* | 2.0343 | 0.664 | 1.546 | 56.092 |
| 4* | −4.988 | 0.03 | | |
| 5 | Infinity | 0.22 | 1.644 | 23.517 |
| 6* | 2.9849 | 0.3392 | | |
| 7* | 3.3859 | 0.2783 | 1.644 | 23.517 |
| 8* | 3.4587 | 0.2577 | | |
| 9* | −1.8199 | 0.7775 | 1.546 | 56.092 |
| 10* | −0.967 | 0.1 | | |
| 11* | 1.4551 | 0.4929 | 1.546 | 56.092 |
| 12* | 0.7556 | 0.3533 | | |
| 13 | Infinity | 0.21 | | |
| 14 | Infinity | 0.9247 | | |
| IMG | Infinity | −0.0047 | | |

The following table shows aspherical surface coefficients.

TABLE 6

| Surfaces | K | A | B | C | D |
|---|---|---|---|---|---|
| 3 | −0.7248 | −0.0102 | −0.0553 | 0.0039 | 0.0186 |
| 4 | 0 | −0.0217 | −0.1382 | 0.0731 | −0.0205 |
| 6 | −14.1695 | 0 | 0.1229 | −0.1303 | 0.0788 |
| 7 | 0 | −0.2193 | −0.0791 | 0.0557 | −0.1024 |
| 8 | 0 | −0.0886 | −0.1111 | 0.1122 | −0.0722 |
| 9 | −16.7908 | 0.1161 | −0.085 | 0.0329 | −0.0239 |
| 10 | −1.1543 | 0.0773 | −0.0738 | 0.017 | −0.002 |
| 11 | −10.849 | −0.0949 | −0.017 | 0.0205 | −0.0042 |
| 12 | −3.9757 | −0.1121 | 0.0435 | −0.0137 | 0.0024 |

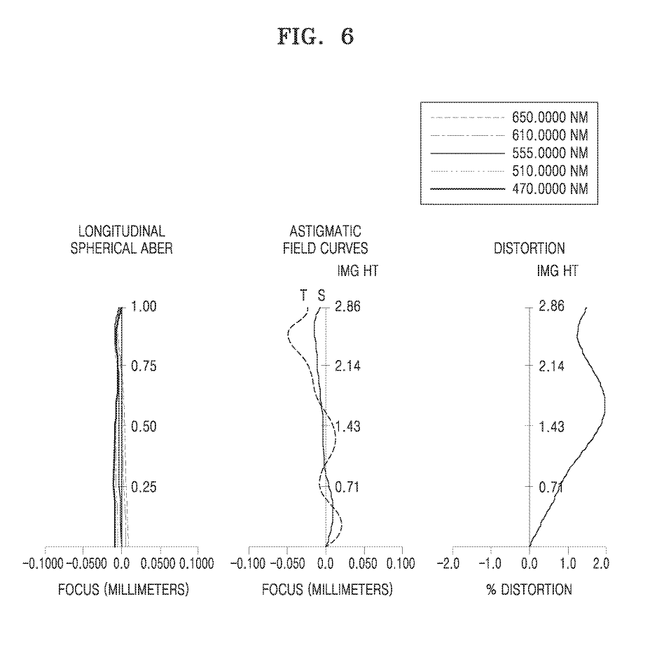

FIG. 6 illustrates a longitudinal spherical aberration, astigmatic field curves, and distortion of the photographic lens 3000 of the third embodiment.

The following table shows that the photographic lenses of the first to third embodiments satisfy Conditions 1, 2, 3, and 4.

TABLE 7

| | | First | Second | Third |
|---|---|---|---|---|
| | | Embodiment | Embodiment | Embodiment |
| Condition 1 | FOV | 83.745 | 82.739 | 82.743 |
| Condition 2 | ImgH | 6.000 | 6.000 | 6.000 |
| | TTL | 4.639 | 4.656 | 4.643 |
| | TTL/ImgH | 0.773 | 0.776 | 0.774 |
| Condition 3 | AL | 4.589 | 4.576 | 4.593 |
| | AL/TTL | 0.989 | 0.983 | 0.989 |
| Condition 4 | Ind2 | 1.644 | 1.644 | 1.644 |
| | Ind3 | 1.644 | 1.644 | 1.644 |
| | (Ind2 + Ind3)/2 | 1.644 | 1.644 | 1.644 |

Since each of the photographic lenses is constructed using five lenses, it may be easy to correct aberrations of the photographic lenses. In addition, the photographic lenses may be small and lightweight.

If aspherical lenses of the photographic lenses include a plastic material, inexpensive, high-performance optical systems may be provided.

The photographic lenses may be small and may have a wide FOV.

The photographic lenses of the embodiments may be used in various photographic apparatuses together with image sensors converting optical images formed by the photographic lenses into electric signals, and such photographic apparatuses may be used in various electronic devices or other devices such as portable terminals, door phones, and automobiles.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the inventive concept as defined by the following claims.

What is claimed is:

1. A photographic lens comprising:
a first lens having a positive refractive power;
a second lens having a negative refractive power;
a third lens having a positive refractive power;
a fourth lens having a positive refractive power; and
a fifth lens having a negative refractive power, wherein the first to fifth lenses are sequentially arranged in a direction from an object toward an image plane, and the photographic lens satisfies the following conditions:
75°<FOV<90°
0.7<TTL/ImgH<0.8
where FOV refers to a field of view of the photographic lens, TTL refers to a distance measured along an optical axis from an entrance surface of the first lens to the image plane, and imgH refers to an image height.

2. The photographic lens of claim 1, wherein the entrance surface of the first lens is convex toward the object.

3. The photographic lens of claim 1, wherein an entrance surface of the second lens is flat.

4. The photographic lens of claim 1, wherein an exit surface of the third lens is concave toward the image plane.

5. The photographic lens of claim 1, wherein an exit surface of the fourth lens is convex toward the image plane.

6. The photographic lens of claim 1, wherein an exit surface of the fifth lens is an aspherical surface having at least one inflection point.

7. The photographic lens of claim 1, wherein the first to fifth lenses comprise a plastic material, and each of the first to fifth lenses is an aspherical plastic lens having at least one aspherical surface.

8. The photographic lens of claim 1, wherein the photographic lens satisfies the following condition:
1.6<(Ind2+Ind3)/2<1.7
where Ind2 refers to a refractive index of the second lens, and ind3 refers to a refractive index of the third lens.

9. The photographic lens of claim 1, further comprising an aperture stop at an object-side of the first lens.

10. The photographic lens of claim 9, wherein the photographic lens satisfies the following condition:
0.9<AL/TTL<1.0
where AL refers to a distance from the aperture stop to the image plane, and TTL refers to the distance measured along the optical axis from the entrance surface of the first lens to the image plane.

11. A photographic lens comprising:
a first lens having a positive refractive power;
a second lens having a negative refractive power and a flat entrance surface;
a third lens having a positive refractive power;
a fourth lens having a positive refractive power; and
a fifth lens having a negative refractive power and an aspherical exit surface, the aspherical exit surface of the fifth lens having at least one inflection point, wherein the first to fifth lenses are sequentially arranged in a direction from an object toward an image plane, and the photographic lens satisfies the following condition:
75°<FOV<90°
where FOV refers to a field of view of the photographic lens.

12. The photographic lens of claim 11, wherein the photographic lens satisfies the following condition:
0.7<TTL/ImgH<0.8
where TTL refers to a distance measured from an optical axis from an entrance surface of the first lens to the image plane, and imgH refers to an image height.

13. The photographic lens of claim 11, wherein the photographic lens satisfies the following conditions:
1.6<Ind2<1.7
1.6<Ind3<1.7
where Ind2 refers to a refractive index of the second lens, and ind3 refers to a refractive index of the third lens.

14. A photographic apparatus comprising:
the photographic lens of claim 1; and
an image sensor converting an optical image formed by the photographic lens into an electric signal.
